(19) United States
(12) Patent Application Publication
(10) Pub. No.: US 2024/0103497 A1
(43) Pub. Date: Mar. 28, 2024

(54) SYSTEMS AND METHODS FOR UNCERTAINTY MEASUREMENT AND REPORTING FOR EMISSIONS

(71) Applicant: Sensia Netherlands B.V., Rotterdam (NL)

(72) Inventor: Alexander Harry Roskoss, York (GB)

(73) Assignee: Sensia Netherlands B.V., Rotterdam (NL)

(21) Appl. No.: 18/371,381

(22) Filed: Sep. 21, 2023

Related U.S. Application Data
(60) Provisional application No. 63/409,172, filed on Sep. 22, 2022.

(51) Int. Cl. G05B 19/416

(52) U.S. Cl. CPC G05B 19/416; G05B 2219/37371

(57) ABSTRACT

A computing system is communicatively couple with a remote terminal unit (RTU) configured to monitor and/or control one or more operations of one or more site devices associated with a hydrocarbon site. The computing system determines an amount of emissions associated with a flare operation at the hydrocarbon site and an uncertainty value for the amount of emissions associated with the flare operation. Alternatively or in addition, the computing system can also be configured determine a total emissions for the hydrocarbon site or multiple hydrocarbons sites and an uncertainty parameter for the total emissions for the hydrocarbon site and or multiple hydrocarbons sites.

### CROSS-REFERENCE TO RELATED APPLICATIONS

This application claims the benefit of and priority to U.S. Provisional Application No. 63/409,172, filed Sep. 22, 2022, the entire disclosure of which is incorporated by reference herein.

### BACKGROUND

The present disclosure relates generally to systems that monitor and report emissions including but not limited to pollution, carbon, greenhouse gasses, and other emissions. In recent years, companies have started to report on their global energy usage (e.g., carbon consumption). For example, large businesses in the United Kingdom are required to disclose annual energy use and greenhouse gas emissions. Schemes for trading greenhouse gasses rely on the “cap and trade” principle, where a cap is set on the total amount of emissions a sector can emit. Measuring emissions is an important first step to managing the level of emissions and giving companies an understanding of what main emissions. A hydrocarbon site such as a well site can produce emissions. One type of hydrocarbon site is a natural gas site that produces or transports natural gas. Such sites can produce significant carbon emissions associated with the drilling, pumping, transportation, and processing activities at the site.

### SUMMARY OF THE INVENTION

Some embodiments relate to a method for a cloud-computing system to communicatively couple with a remote terminal unit (RTU) that monitors and/or controls one or more operations associated with a hydrocarbon well. The method includes receiving, via at least one processor, and receiving parameter and certainty associated with the parameters. The method also include determining an amount of emissions and an uncertainty value associated with the amount of emissions.

Some embodiments relate to a computing system. The computing system includes a sensor configured to measure a flow rate and a processor. The processor is configured to receive the flow rate and determine an amount of emissions associated with the flow rate and an uncertainty value for the amount of emissions.

In some embodiments, the flow rate is associated with a flare operation. The processor is configured to receive a composition measurement, an uncertainty parameter associated with the flow rate and an uncertainty parameter associated with the composition measurement. The amount of emissions is related to the composition measurement, and the uncertainty value is determined using the uncertainty parameter associated with the flow rate and the uncertainty parameter associated with the composition measurement.

In some embodiments, the flow rate is associated with a flare operation. The processor is configured to receive a composition measurement, an uncertainty parameter associated with the flow rate, an uncertainty parameter associated with the composition measurement, weather information, and an uncertainty parameter associated with the weather information. The amount of emissions is related to the composition measurement and the weather information. The uncertainty value is determined using the uncertainty parameter associated with the flow rate, the uncertainty parameter associated with the composition measurement and the uncertainty parameter associated with the weather information.

In some embodiments, the flow rate is associated with a flare operation. The processor is configured to receive a composition measurement, an uncertainty parameter associated with the flow rate, an uncertainty parameter associated with the composition measurement, weather information, an uncertainty parameter associated with the weather information, an added material measurement, and an uncertainty parameter associated with the added material. The amount of emissions is related to the composition measurement, the added material measurement, and the weather information. The uncertainty value is determined using the uncertainty parameter associated with the flow rate, the uncertainty parameter associated with the composition measurement, the uncertainty parameter associated with the weather information, and the uncertainty parameter associated with the added material measurement.

In some embodiments, the added material measurement is for added fuel, added air or added steam. In some embodiments, the weather information is wind speed or wind direction. In some embodiments, the processor is configured to determine a combustion efficiency measurement, a destruction and removal efficiency measurement, an uncertainty parameter for the combustion efficiency measurement, and an uncertainty parameter for the destruction and removal efficiency measurement.

In some embodiments, the processor is configured to determine a carbon dioxide emission site measurement and uncertainty parameter for the carbon dioxide site measurement. In some embodiments, the processor is configured to determine a carbon dioxide emission multi-site measurement and uncertainty parameter for the carbon dioxide site measurement. In some embodiments, the processor is configured to determine an emissions cost estimate measurement and uncertainty parameter for the emissions cost estimate measurement.

Some embodiments relate to a computing system to communicatively couple with a remote terminal unit (RTU) configured to monitor and/or control one or more operations of one or more site devices associated with a hydrocarbon site. The computing system includes a processor configured to determine an amount of emissions associated with a flare operation at the hydrocarbon site and an uncertainty value for the amount of emissions associated with the flare operation, and determine an amount of emissions associated with fuels at the hydrocarbon site and an uncertainty value for the amount of emissions associated with the fuels. The processer is also configured to determine a total emissions for the hydrocarbon site using the amount of emissions associated with the flare operation and the amount of emissions associated with the fuels, and determine an uncertainty parameter for the total emissions for the hydrocarbon site using the uncertainty parameter for the amount of emissions associated with the flare operation and the uncertainty parameter for the amount of emissions associated with the fuels.

In some embodiments, the amount of emissions associated with the fuel uses a fuel grade measurement, a gauge reading, and an efficiency parameter.

In some embodiments, the processor is configured to receive a composition measurement, an uncertainty parameter associated with the flow rate, an uncertainty parameter associated with the composition measurement, weather information, and an uncertainty parameter associated with the weather information. The amount of emissions associated with the flare operation is related to the composition measurement and the weather information. The uncertainty parameter for the amount of emissions associated with the flare operation is determined using the uncertainty parameter associated with the flow rate, the uncertainty parameter associated with the composition measurement and the uncertainty parameter associated with the weather information.

In some embodiments, the processor is configured to receive an added material measurement, and an uncertainty parameter associated with the added material. The amount of emissions associated with the flare operation is related to the added material measurement. The uncertainty parameter for the amount of emissions associated with the flare operation is determined using the uncertainty parameter associated with the added material measurement.

In some embodiments, the added material measurement is for added fuel, added air or added steam. In some embodiments, the weather information is wind speed or wind direction.

In some embodiments, the processor is configured to determine a combustion efficiency measurement for the hydrocarbon site, a destruction and removal efficiency measurement for the hydrocarbon site, an uncertainty parameter for the combustion efficiency measurement, and an uncertainty parameter for the destruction and removal efficiency measurement. In some embodiments, the processor is configured to determine a carbon dioxide emission site measurement and uncertainty parameter for a number of hydrocarbon sites.

Some embodiments relate to a method. The method includes receiving a flow rate for a flare operation, and receiving an uncertainty parameter for the flow rate. The method also includes determining an amount of emissions for the flare operation using the flow rate, and determining an uncertainty value for the amount of emissions using the uncertainty parameter for the flow rate. The method also includes reporting compliance with a flare gas consent using the uncertainty value for the amount of emissions and the amount of emissions for the flare operation.

In some embodiments, the method further includes receiving a composition measurement, an uncertainty parameter associated with the flow rate and an uncertainty parameter associated with the composition measurement. The amount of emissions for the flare operation is related to the composition measurement. The uncertainty value for the amount of emissions is determined using the uncertainty parameter associated with the flow rate and the uncertainty parameter associated with the composition measurement.

In yet another embodiment, a non-transitory computer-readable medium may include computer-executable instructions that cause a computing device to provide the emission and emission uncertainty information for a hydrocarbon site.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of a high-level overview of an industrial enterprise including a cloud-based computing system, in accordance with some embodiments presented herein;

FIG. 2 illustrates a schematic diagram of an example hydrocarbon site that may produce and process hydrocarbons, in accordance with some embodiments presented herein;

FIG. 3 illustrates an example overview of a cloud-based communication architecture for the example hydrocarbon site of FIG. 2, in accordance with some embodiments presented herein;

FIG. 4 illustrates a block diagram of a system for determining emissions associated with a hydrocarbon site or multiple hydrocarbon sites, in accordance with some embodiments presented herein;

FIG. 5 illustrates a more detailed block diagram of a system for determining emissions uncertainty associated with a hydrocarbon site in accordance with some embodiments presented herein;

FIG. 6 illustrates a display showing a table for absolute and relative uncertainty for parameters provided by the system illustrated in FIGS. 5; and

FIGS. 7-9 illustrates a display showing charts for parameters provided by the systems illustrated in FIGS. 4 and 5.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another.

Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure are generally directed towards improved systems and methods for monitoring of emissions. The systems and methods advantageously provide a dynamic combination of metering data, emissions calculations and estimates of measurement uncertainty in some embodiments. In some embodiments, uncertainty parameters for emissions measurement are provided in a live (e.g., real time or near real time fashion). Although embodiments are described herein with respect to natural gas production and transportation, the systems and method disclosed herein can be used with other applications (chemical, manufacturing, mining, agricultural, transportation, etc.) Uncertainty parameters can be provided by meters and analyzers. Uncertainty parameters are generally a measure of accuracy or sensitivity of a measurement or data. Certain uncertainty calculations can involve a comparison to prior readings, relate to a signal—to noise ratio, a type of sensor, or other data indicative of accuracy or precision. In some embodiments, uncertainty is calculated using standard deviation, such as, standard deviation=the square root of Σ(xᵢ−μ)²/N, where xᵢ are measurements, μ is the mean of measurements and N is the number of measurements, and i is an integer from 1 to N.

In some embodiments, a combination of live measurement data, environmental emissions calculations and near real-time measurement uncertainty estimates are used to provide live emissions values with associated uncertainty values. In some embodiments, live measurements of material flow rates along with composition analysis of these materials and live data on combustion conditions can be combined to provide carbon dioxide and carbon dioxide equivalent emissions rates and totals for processes. Combining these automatically with calculated estimates of measurements uncertainty relating the specific live conditions allows for a near real-time measurement uncertainty estimates to be produced for the emissions reported in some embodiments. These live emissions rates and quantities and their associated uncertainties can be combined for period totalization.

Provision of live emissions rates and their associated uncertainties through electronic computation can be achieved with a suitably configured device physically close to the metering devices or through processing of data relevant to the flow measurement, analysis and uncertainty estimation which has been passed to a system remote from site in some embodiments. Moreover, embodiments of the present disclosure are related to leveraging a cloud-based computing network to perform various operations more efficiently.

In some embodiments, information related to weather, related to the extracted hydrocarbons or related to the equipment extracting, transporting, storing, or processing the extracted hydrocarbons may be gathered at the well site or at various locations along the network of pipelines. This information or data may be used to determine emissions and uncertainty associated with those emissions. The data related to the extracted hydrocarbons may be acquired using monitoring devices that may include sensors that acquire the data and transmitters that transmit the data to computing devices, routers, other monitoring devices, and the like, such that well site personnel and/or off-site personnel may view and analyze the data. In addition to monitoring the properties of the well device and the hydrocarbon well site, the monitoring devices, such as remote terminal units (RTUs), control the operations of a well device used for extracting hydrocarbons from the hydrocarbon well site. Generally, the RTUs store and execute control programs and monitoring programs to effect decision-making in connection with a process for controlling the operation of the well device. The decisions making can be in response to emissions data and uncertainty data associated therewith.

In some embodiments, the systems and methods are configured for increased data integrity, reduced manual intervention, increased automation, and simpler emissions and uncertainty reporting. In some embodiments, the systems and methods provide a graphical display of compliance to flare consents with daily emissions totals and uncertainty. In some embodiments, the systems and methods track flare emissions against consents, vent gas against consents, and emissions against carbon credits and provide uncertainty values. Reports of mass carbon dioxide and associated uncertainty for streams and totals for stations can be provided.

In some embodiments, more accurate or up-to-date uncertainty information prevents over reporting of emissions or under reporting of emissions. Evaluating uncertainty of environmental metering systems on an on-going basis provides the opportunity for interventions to reduce measurement uncertainty and prevent exposure to over reporting and demonstrate compliance. By providing estimated emission uncertainty more frequently than on a snap-shot basis, the actual conditions of operation can be monitored as they change over time and controlled accordingly in some embodiments.

Cloud-Based Computing System

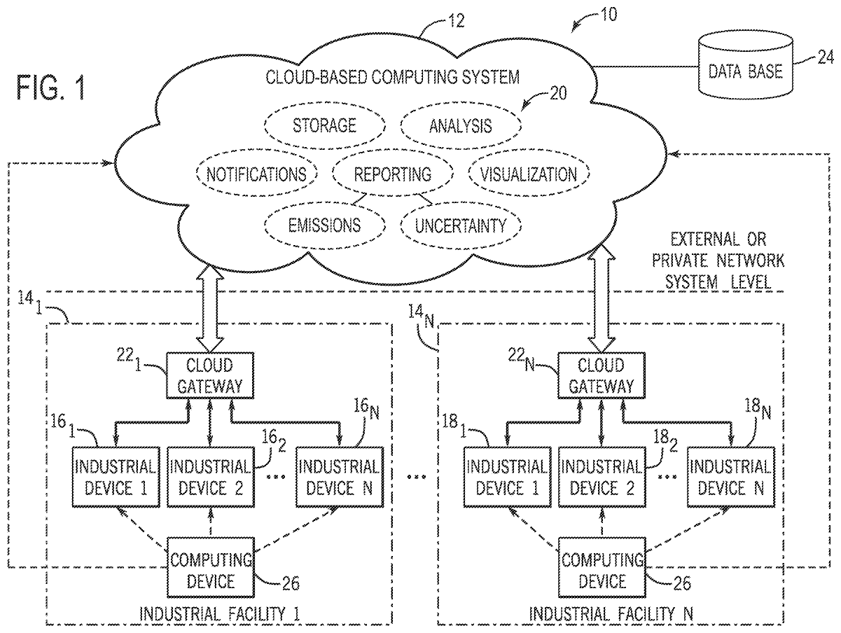

By way of introduction, FIG. 1 illustrates a high-level overview of an industrial enterprise such as a hydrocarbon site 10 that leverages a cloud-based computing system to improve the operations of various industrial devices. The enterprise or hydrocarbon site 10 may include one or more industrial facilities 14, each having a number of industrial devices 16 and 18 in use. The industrial devices 16 and 18 may make up one or more automation systems operating within the respective facilities 14. Exemplary automation systems may include, but are not limited to, batch control systems (e.g., mixing systems), continuous control systems (e.g., proportional-integral-derivative (PID) control systems), or discrete control systems. Industrial devices 16 and 18 may also include devices, such as industrial controllers (e.g., programmable logic controllers or other types of programmable automation controllers), field devices such as sensors and meters, motor drives, operator interfaces (e.g., human— machine interfaces, industrial monitors, graphic terminals, message displays, etc.), industrial robots, barcode markers and readers, vision system devices (e.g., vision cameras), smart welders, or other such industrial devices.

In certain embodiments, the industrial devices 16 and 18 may communicatively couple to a computing device 26. The communication link between the industrial devices 16 and 18 and the computing device 26 may be a wired or a wireless connection, such as Wi-Fi®, Bluetooth®, and the like. Generally, the computing device 26 may be any type of processing device that may include communication abilities, processing abilities, and the like. For example, the computing device 26 may be a controller, such as a programmable logic controller (PLC), a programmable automation controller (PAC), or any other controller that may monitor, control, and operate the industrial device 16 and 18. The computing device 26 may be incorporated into any physical device (e.g., the industrial device 16 and 18) or may be implemented as a stand-alone computing device (e.g., general purpose computer), such as a desktop computer, a laptop computer, a tablet computer, a mobile computing device, or the like.

In addition to communicating with the industrial devices 16 and 18, the computing device 26 may also establish a communication link with the cloud-based computing system 12. As such, the computing system 26 may have access to a number of cloud-based services provided by the cloud-based computing system 12, as will be described in more detail below. Generally, the computing device 26 may send and receive data to and from the cloud-based computing system 12 to assist a user of the industrial device 16 or 18 in the commissioning, operation, and maintenance of the industrial automation systems.

Exemplary automation systems can include one or more industrial controllers that facilitate monitoring and control of their respective processes and emissions. The controllers may exchange data with the field devices using native hardwired I/O or via a plant network such as Ethernet/IP, Data Highway Plus, ControlNet, DeviceNet, or the like. A given controller may receive any combination of digital or analog signals from the field devices indicating a current state of the devices, their associated processes, and uncertainty related thereto (e.g., temperature, position, part presence or absence, fluid level, etc.), and executes a user-defined control program that performs automated decision-making for the controlled processes based on the received signals. The controller may then output appropriate digital and/or analog control signaling to the field devices in accordance with the decisions made by the control program. These outputs may include device actuation signals, temperature or position control signals, operational commands to a machining or material handling robot, mixer control signals, motion control signals, and the like. The control program may include any suitable type of code used to process input signals read into the controller and to control output signals generated by the controller, including but not limited to ladder logic, sequential function charts, function block diagrams, structured text, or other such platforms.

Although the industrial enterprise or hydrocarbon site 10 illustrated in FIG. 1 depicts the industrial devices 16 and 18 as residing in fixed-location industrial facilities 14, the industrial devices 16 and 18 may also be part of a mobile control application, such as a system contained in a truck or other service vehicle. Additionally, although the industrial enterprise or hydrocarbon site 10 of FIG. 1 is described with respect to hydrocarbon production well sites, it should be noted that the systems and method for the industrial enterprise or hydrocarbon site 10 described herein may be applied to other automation systems.

In certain embodiments, the industrial devices 16 and 18 may be communicatively coupled to the cloud-based computing system 12 that may provide various applications, analysis operations, and access to data that may be unavailable to the industrial devices 16 and 18. The industrial devices can produce measurements and uncertainty values associated with the measurements. In some embodiments, the industrial device 16 and 18 may interact with the cloud-based computing system 12, such that the industrial device 16 and 18 may use various cloud-based services 20 to perform its respective operations more efficiently or effectively. The cloud-based computing system 12 may be any infrastructure that enables the cloud-based services 20 to be accessed and utilized by cloud-capable devices. In one embodiment, the cloud-based computing system 12 may include a number of computers that may be connected through a real-time communication network, such as the Internet, Ethernet/IP, ControlNet, or the like. By employing a number of computers, the cloud-based computing system 12 may distribute large-scale analysis operations over the number of computers that make up the cloud-based computing system 12.

Generally, the computers or computing devices provided by the cloud-based computing system 12 may be dedicated to performing various types of complex and time-consuming analysis that may include analyzing a large amount of data. In some embodiments, the computers or computing devices provided by the cloud-based computing system 12 provide emissions reporting and uncertainty values for emissions. In some embodiments, the emission reporting can include graphical displays of compliance to flare consents with daily emissions totals and uncertainty. In some embodiments, the emissions reporting includes tracking flare emissions against consents, vent gas against consents, and emissions against carbon credits along with uncertainty values for each. Reports of mass carbon dioxide and associated uncertainty for streams and totals for stations can be provided as part of the emissions reporting. As a result, the industrial device 16 or 18 may continue its respective processing operations without performing additional processing or analysis operations that may involve analyzing large amounts of data collected from other data sources.

In certain embodiments, the cloud-based computing system 12 may be a public cloud accessible via the Internet by devices having Internet connectivity and appropriate authorizations to utilize the cloud-based services 20. In some scenarios, the cloud-based computing system 12 may be a platform-as-a-service (PaaS), and the cloud-based services 20 may reside and execute on the cloud-based computing system 12. In some embodiments, cloud-based computing system−is configured to provide, storage, notifications, reporting, visualization, and analysis of emissions and uncertainty.

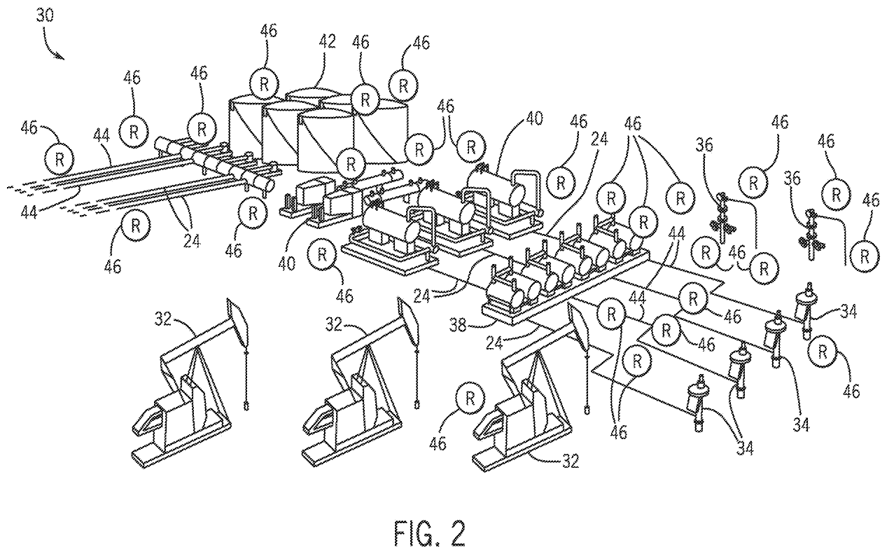

Referring now to FIG. 2, the hydrocarbon site 10 can be embodied as hydrocarbon site 30. Hydrocarbon site 30 is an area in which hydrocarbons, such as crude oil and natural gas, may be extracted from the ground, processed, and stored in some embodiments. As such, the hydrocarbon site 30 may include a number of wells and a number of well devices that may control the flow of hydrocarbons being extracted from the wells. In one embodiment, the well devices at the hydrocarbon site 30 may include any device equipped to monitor and/or control production of hydrocarbons at a well site. As such, the well devices may include pumpjacks 32, submersible pumps 34, well trees 36, and the like. After the hydrocarbons are extracted from the surface via the well devices, the extracted hydrocarbons may be distributed to other devices such as wellhead distribution manifolds 38, separators 40, storage tanks 42, and the like. At the hydrocarbon site 30, the pumpjacks 32, submersible pumps 34, well trees 36, wellhead distribution manifolds 38, separators 40, and storage tanks 42 may be connected together via a network of pipelines 44. As such, hydrocarbons extracted from a reservoir may be transported to various locations at the hydrocarbon site 30 via the network of pipelines 44. Conduits used on hydrocarbon site 30 may include flow meters for providing flow measurements and uncertainty values for the flow measurements.

The pumpjack 32 may mechanically lift hydrocarbons (e.g., oil) out of a well when a bottom hole pressure of the well is not sufficient to extract the hydrocarbons to the surface. The submersible pump 34 may be an assembly that may be submerged in a hydrocarbon liquid that may be pumped. As such, the submersible pump 34 may include a hermetically sealed motor, such that liquids may not penetrate the seal into the motor. Further, the hermetically sealed motor may push hydrocarbons from underground areas or the reservoir to the surface.

The well trees 36 or Christmas trees may be an assembly of valves, spools, and fittings used for natural flowing wells. As such, the well trees 36 may be used for an oil well, gas well, water injection well, water disposal well, gas injection well, condensate well, and the like. The wellhead distribution manifolds 38 may collect the hydrocarbons that may have been extracted by the pumpjacks 32, the submersible pumps 34, and the well trees 36, such that the collected hydrocarbons may be routed to various hydrocarbon processing or storage areas in the hydrocarbon site 30.

The separator 40 may include a pressure vessel that may separate well fluids produced from oil and gas wells into separate gas and liquid components. For example, the separator 40 may separate hydrocarbons extracted by the pumpjacks 32, the submersible pumps 34, or the well trees 36 into oil components, gas components, and water components. After the hydrocarbons have been separated, each separated component may be stored in a particular storage tank 42. The hydrocarbons stored in the storage tanks 42 may be transported via the pipelines 44 to transport vehicles, refineries, and the like. The well devices can also include flaring and venting mechanisms such as systems for flaring and venting natural gas sources.

The well devices may also include monitoring systems that may be placed at various locations in the hydrocarbon site 30 to monitor or provide information related to certain aspects of the hydrocarbon site 30. As such, the monitoring system may be a flow meter, temperature sensor, pressure sensor, composition analyzer, density analyzer, controller, a remote terminal unit (RTU), any computing device that may include communication abilities, processing abilities, sensor and the like. For discussion purposes, the monitoring system will be embodied as the RTU 46 throughout the present disclosure. However, it should be understood that the RTU 46 may be any component capable of monitoring and/or controlling various components at the hydrocarbon site 30.

The RTU 46 may include sensors or may be coupled to various sensors that may monitor various properties associated with a component at the hydrocarbon site 10. The RTU 46 may then analyze the various properties associated with the component and may control various operational parameters of the component. For example, the RTU 46 may measure a pressure or a differential pressure of a well or a component (e.g., storage tank 42) in the hydrocarbon site 30 and associated uncertainty. The RTU 46 may also measure a temperature of contents stored inside a component in the hydrocarbon site 30, an amount of hydrocarbons being processed or extracted by components in the hydrocarbon site 30, and the like and associated uncertainty. The RTU 46 may also measure a level or amount of hydrocarbons stored in a component, such as the storage tank 42. In certain embodiments, the RTU 46 may be iSens-GP Pressure Transmitter, iSens-DP Differential Pressure Transmitter, iSens-MV Multivariable Transmitter, iSens-T2 Temperature Transmitter, iSens-L Level Transmitter, or Isens-IO Flexible I/O Transmitter manufactured by vMonitor® of Houston, Texas.

In one embodiment, the RTU 46 may include a sensor that may measure pressure, temperature, fill level, flow rates, and the like and associated uncertainty. The RTU 46 may also include a transmitter, such as a radio wave transmitter, that may transmit data acquired by the sensor via an antenna or the like. The sensor in the RTU 46 may be wireless sensors that may be capable of receive and sending data signals between computing systems 26 (e.g., RTUs). To power the sensors and the transmitters, the RTU 46 may include a battery or may be coupled to a continuous power supply. Since the RTU 46 may be installed in harsh outdoor and/or explosion-hazardous environments, the RTU 46 may be enclosed in an explosion-proof container that may meet certain standards established by the National Electrical Manufacturer Association (NEMA) and the like, such as a NEMA 4X container, a NEMA 7X container, and the like.

The RTU 46 may transmit data acquired by the sensor or data processed by a processor to other monitoring systems, a router device, a supervisory control and data acquisition (SCADA) device, or the like. As such, the RTU 46 may enable users to monitor various properties of various components in the hydrocarbon site 30 without being physically located near the corresponding components.

In operation, the RTU 46 may receive real-time or near real-time data associated with a well device. The data may include, for example, tubing head pressure, tubing head temperature, case head pressure, flowline pressure, wellhead pressure, wellhead temperature, and the like. In any case, the RTU 46 may analyze the real-time data with respect to static data that may be stored in a memory of the RTU 46. The static data may include a well depth, a tubing length, a tubing size, a choke size, a reservoir pressure, a bottom hole temperature, well test data, fluid properties of the hydrocarbons being extracted, and the like. The RTU 46 may also analyze the real-time data with respect to other data acquired by various types of instruments (e.g., water cut meter, multiphase meter) to determine an inflow performance relationship (IPR) curve, a desired operating point for the wellhead or hydrocarbon site 30, key performance indicators (KPIs) associated with the wellhead or hydrocarbon site 30, wellhead performance summary reports, and the like and associated uncertainty. Although the RTU 46 may be capable of performing the above-referenced analyses, the RTU 46 may not be capable of performing the analyses in a timely manner.

In some embodiments, the RTU 46 may establish a communication link with the cloud-based computing system 12 described above. As such, the cloud-based computing system 12 may use its larger processing capabilities to analyze data acquired by multiple computing systems 26 (e.g., RTUs). Moreover, the cloud-based computing system 12 may access historical data associated with the respective RTU 46, data associated with well devices associated with the respective RTU 46, data associated with the hydrocarbon site 30 associated with the respective RTU 46 and the like to further analyze the data acquired by the RTU 46.

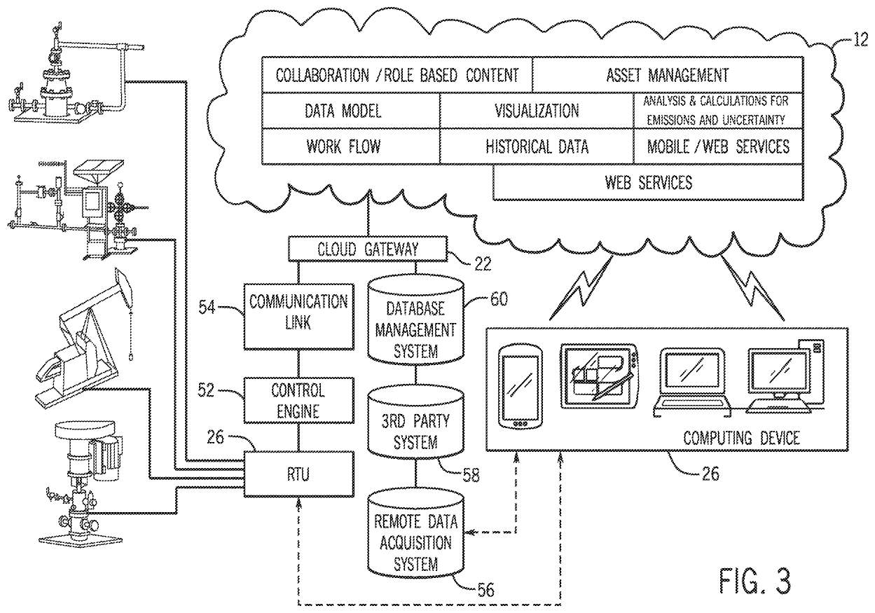

Accordingly, in one embodiment, the RTU 46 may communicatively couple to the cloud-based computing system 12 via a cloud-based communication architecture or services 20 as shown in FIG. 3. Referring to FIG. 3, the RTU 46 may communicatively couple to a control engine 52 such as ControlLogix® or the like. The control engine 52 may, in turn, communicatively couple to a communication link 54 that may provide a protocol or specifications such as OPC Data Access that may enable the control engine 52 and the RTU 46 to continuously communicate its data to the cloud-based computing device 12 or computing system 26. The communication link 54 may be communicatively coupled to the cloud gateway 22, which may then provide the control engine 52 and the RTU 46 access to communicate with the cloud-based computing system 12. Although the RTU 46 is described as communicating with the cloud-based computing system 12 via the control engine 52 and the communication link 54, it should be noted that in some embodiments, the RTU 46 may communicate directly with the cloud gateway 22 like the industrial device 16 and 18 of FIG. 1 or may communicate directly with the cloud-based computing system 12.

In some embodiments, the computing systems 26 (e.g., RTU) may communicatively couple to the control engine 52 or the communication link 54 via an Ethernet IP/Modbus network. As such, a polling engine may connect to the computing systems 26 (e.g., RTU) via the Ethernet IP/Modbus network to poll the data acquired by the computing systems 26 (e.g., RTU). The polling engine may then use an Ethernet network to connect to the cloud-based computing system 12.

As mentioned above, the RTU 46 may monitor and control various types of well devices and may send the data acquired by the respective well devices to the cloud— based computing system 12 according to the architecture described above. For example, as shown in FIG. 3, the RTU 46 may monitor and control an electrical submersible pump (ESP), a gas lift (GL), a rod pump controller (RPC), a progressive cavity pump (PCP), and the like. In the ESP, the RTU 46 may sense and control the wellhead and other operating variables of the ESP system. In the GL, the RTU 46 may adjust a gas lift injection flow to operator flow rate, compute real-time estimated gas-oil-water production, and the like. In the RPC, the RTU 46 may provide advance rod pump controlling operations for beam pump applications and the like. The RTU 46 may also monitor both polish rod load and continuous walking beam position to develop dynamometer cards. In the PCP, the RTU 46 may provide local and remote monitoring of the wellhead and other PCP variable. Here, the RTU 46 may also perform basic analysis and adjust the pumping conditions of the PCP based on the received data from the PCP.

In addition to the RTU 46 and the control engine 52 being able to communicate with the cloud-based computing system 12, remote data acquisition systems 56, third party systems 58, and database management systems 60 may also communicatively couple to the cloud gateway 22. The remote data acquisition systems 56 may acquire real-time data transmitted by various data sources such as the RTU 46 and other third party systems 58. The database management system 60 may be a relational database management system that stores and retrieves data as requested by various software applications. By way of example, the database management system 60 may be a SQL server, an ORACLE server, a SAP server, or the like.

As mentioned above, the computing device 26 may communicatively couple to the RTU 46 and the cloud-based computing system 12. As shown in FIG. 3, the computing device 26 may include a mobile device, a tablet device, a laptop, a general purpose computer, or the like. In certain embodiments, the computing device 26 may also communicatively couple with the remote data acquisition systems 56, the third party system 58, and the database management system 60. By communicating with all of these types of devices, the computing device 26 may receive data and generate visualizations associated with each respective device, thereby providing the user of the computing device 26 a more efficient manner in which to view and analyze the data. Moreover, since the computing device 26 may receive data from the cloud-based computing system 12, the computing device 26 may receive visualizations and data related to various types of analyses (e.g., emissions calculations and associated uncertainty calculations) and cloud-based services 20 (e.g., emissions and associated uncertainty reporting) provided by the cloud-based computing system 12.

In some embodiments, the cloud-based computing system 12 may include applications related to collaboration or role based content, asset management, data models, visualizations, analysis & calculations, workflows, historical data, mobile web services, web services, and the like. The collaboration or role-based application may include facilitating collaboration between various users of the cloud-based computing system 12 to assist in the commission, operation, or maintenance of well devices at the hydrocarbon site 30. The asset management application may track the hardware and software maintenance of the well devices and the software used therein. The data model application may include algorithms that may simulate various types of data related to the production of hydrocarbons by a well device, the production of hydrocarbons at a hydrocarbon site, and the like based on various process parameter inputs received by the cloud-based computing system 12. The visualization application may generate various types of visualizations such as graphs, tables, data dashboards, and the like based on the data (e.g., emission and uncertainty data) received by the cloud-based computing system 12 and the data available to the cloud-based computing system 12 via the database 24 or the like.

The analysis & calculations applications may include software applications that may provide additional information regarding the data received by the cloud-based computing system 12. For example, the analysis & calculations applications may analyze flow rate data regarding the production of hydrocarbons by a particular well site to determine the amount of hydrocarbons, water, and sand (i.e., multiphase measurements) contained in the produced hydrocarbons. In another example, analysis & calculations applications may determine emission and uncertainty data for emissions as described below.

The workflow applications may be software applications that generate workflows or instructions for users of the well device or personnel at the hydrocarbon site 30 may use to perform their respective tasks. In one example, the cloud-based computing system 12 may generate a workflow regarding the monitoring of emissions, commissioning of a well device, troubleshooting an operation issue with a well device, or the like.

In certain embodiments, the workflow applications may determine the workflows based on historical data stored within the cloud-based computing system 12. That is, the historical data may include data related to previous items produced by any application within the cloud-based computing system 12 such as workflows, data analyses, reports, visualizations, and the like related emissions and uncertainty thereof. Moreover, the historical data may also include raw data acquired by the RTU 46 or any other device and received by the cloud— based computing system 12. As such, the cloud-based computing system 12 may use the historical data to perform additional analyses on the received data, simulate or predict how the operations of a well device may change, simulate how the production of hydrocarbons at a well site may change, emissions and emission uncertainty at the well site, and the like.

The cloud-based computing system 12 may also provide mobile web services and web services that may enable the computing device 26, or any other device communicatively coupled to the cloud-based computing system 12, to access the Internet, Intranet, or any other network that may be available. Moreover, the cloud-based computing system 12 may use the web services to access information related to various analyses that it may be performing and the like.

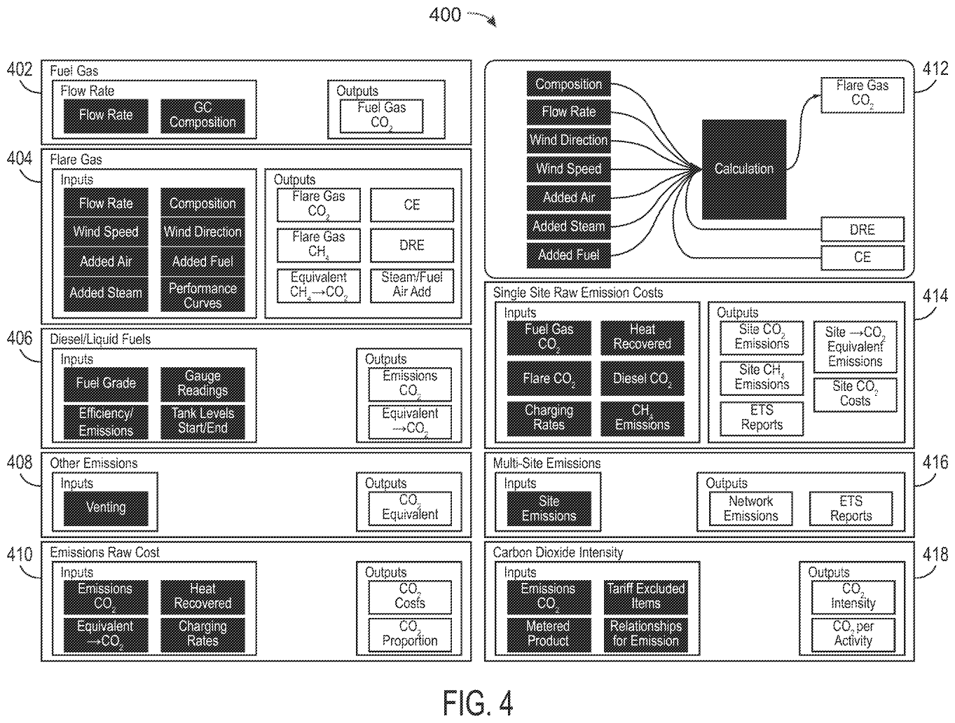

With reference to FIG. 4, system 12 can be configured to measure emissions as a system 400. System 400 can be part of system 12 and include sensors and computing components discussed above to perform the analysis and reporting described below.

System 400 includes a fuel gas module 402, a flare gas module 404, a diesel fuel module 406, an emissions module 408, an emissions raw cost module 410, a flare emissions calculation module or calculator 412, a single site raw emissions cost calculator 414, a multi-site emissions calculator 416, and a carbon dioxide intensity calculator 418. Fuel gas module 402 receives data representative of flow rate and gas chromatography (CT) composition and provides a fuel gas carbon dioxide measurement. Flare gas module 404 receives data representative of flow rate, composition, added air quantity or rate, added steam quantity or rate, added fuel quantity or rate, and performance curves for the flaring operation. Flare gas module 404 also receives data representative of weather at the site including but not limited to wind speed and wind direction. Flare gas module 404 provides a flare gas carbon dioxide measurement, a flare gas methane measurement, a methane to carbon dioxide equivalent measurement, an added air, fuel, and steam measurement, a combustion efficiency measurement, and a destruction and removal efficiency measurement. These measurements can be made based upon readings from sensors such as multi-spectral infrared (IR) imagers or other analyzers that measure relative concentrations of unburned hydrocarbons, product of combustion (i.e., carbon dioxide), and product of incomplete combustion represented by carbon monoxide (CO). The diesel fuel module 406 receives data representative of fuel grade, gauge readings, efficiency and emissions, and tank start and stop levels and provides a carbon dioxide emission measurement associated with the use of diesel or other fuels at the well site and a carbon dioxide equivalent measurement. The emissions module 408 receives data representative of venting parameters and provides a carbon dioxide equivalent measurement for the venting operation. Emissions raw cost module 410 receives a carbon dioxide data, carbon dioxide equivalent data, heat recovered data and charging rate data. Emissions raw cost module 410 provides gas carbon dioxide cost measurement.

Flare emissions calculator 412 receives the data received by flare gas module 404 and provides the flare gas carbon dioxide measurement, the combustion efficiency measurement, and the destruction and removal efficiency measurement provided by flare gas module 404. The flare emissions calculator 412 determines the flare gas carbon dioxide measurement representing emissions associated with the flare operation. Flare emissions calculator 412 can be part of flare gas module 404.

The single site raw emissions cost calculator 414 receives flare gas carbon dioxide measurement by flare gas module 404, the fuel gas carbon dioxide from diesel fuel module 406, the combustion efficiency measurement from flare gas module 404, and the destruction and removal efficiency measurement from flare gas module 404, the charging rates data and heat recovered data received by emissions raw cost module 410, the fuel gas carbon dioxide measurement from fuel gas module 402, and the methane emission measurement from flare gas module 404. The single site raw emissions cost calculator 414 determines a site carbon dioxide measurement representing carbon dioxide emissions associated with the site, a site methane measurement representing methane emissions associated with the site, a site carbon dioxide equivalent measurement representing equivalent carbon dioxide emissions associated with the site, a site carbon dioxide cost measurement representing cost of carbon dioxide emissions associated with the site, and emission training systems (ETS) data associated with the site. The carbon dioxide equivalent measurement converts other emissions such as a methane to carbon dioxide equivalents so that total emissions can be evaluated using carbon dioxide emissions as a scale. The ETS data can be provided in a report for submission to governing bodies associate with emission standards and trading.

The multi-site emissions calculator 416 determines a multi-site or network emissions measurement representing emissions associated with multiple sites, and ETS data associated with multiple sites. The emissions measurement or data can represent carbon dioxide equivalent measurement or a combination of carbon dioxide and other emissions such as a methane. In some embodiments, the emissions data includes carbon dioxide equivalents so that total emissions for the multiple sites can be determined.

The carbon dioxide intensity calculator 418 receives a carbon dioxide measurement representing carbon dioxide emissions associated with a flare operation, single site or multiple sites, a metered product measurement representing product (e.g., natural gas) production associated with a flare operation, single site or multiple sites, tariff excluded items data representing products that are not under carbon tariffs, and relationships for emissions data representing the relationships of products to the emissions data. The carbon dioxide intensity calculator 418 determines a flare operation, a multi-site or single site carbon dioxide intensity measurement, and a flare operation, a multi-site or single site carbon dioxide per activity measurement. Carbon dioxide emissions intensity is defined as carbon dioxide emissions per a unit of production or economic value.

Energy intensity, denoted as energy consumed per GDP, captures the technical efficiency associated with the utilization of energy and production processes in some embodiments. Emission intensity (also carbon intensity, C.I.) is the emission rate of a given pollutant relative to the intensity of a specific activity, or an industrial production process; for example, grams of carbon dioxide released per megajoule of energy produced, or the ratio of greenhouse gas emissions produced to gross production. Emission intensities can be used to derive estimates of air pollutant or greenhouse gas emissions based on the amount of fuel combusted, the number of animals in animal husbandry, on industrial production levels, distances traveled or similar activity data. Emission intensities may also be used to compare the environmental impact of different fuels or activities. Emission factor and carbon intensity can be used interchangeably. Carbon intensity can be provided using carbon intensity per kilowatt-hour (CIPK) or joule unit.

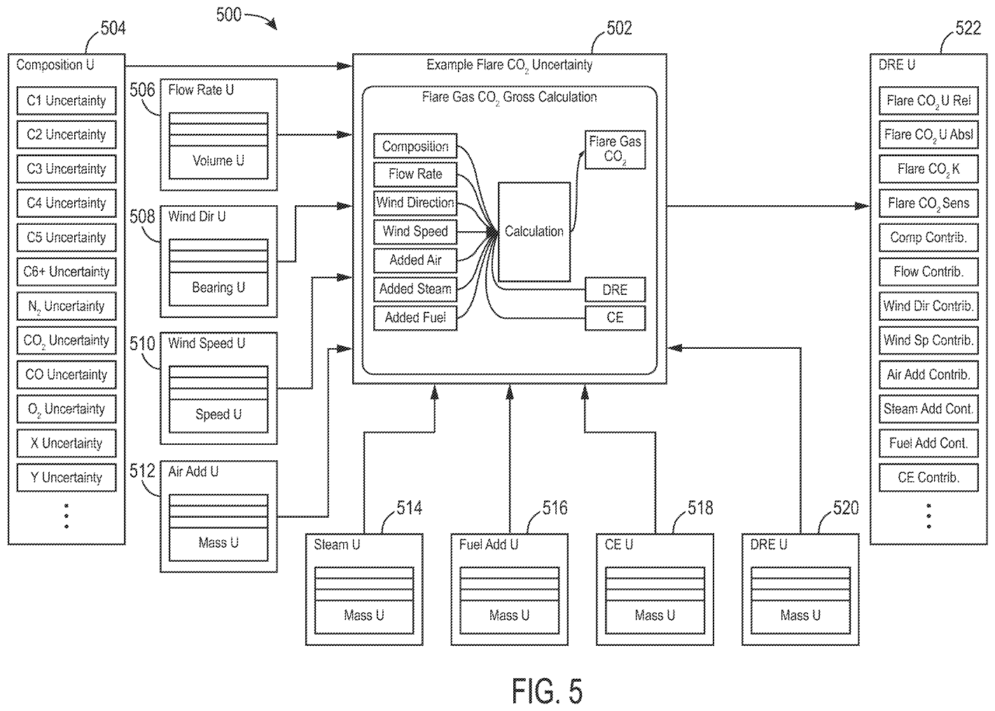

With reference to FIG. 5, a system 500 is configured to provide emission uncertainty data. System 500 can be used for any of the calculations or measurements described above with respect to FIG. 4, including but not limited to flare gas emissions, single site emissions, multi-site emissions, carbon intensity measurements, etc. System 500 can be part of, include, or be in communications with system 400.

System 500 includes a flare gas uncertainty calculator 502. The flare gas uncertainty calculator 502 can be part of or include or be in communication with flare emissions calculator 412. Flare gas uncertainty calculator 502 receives data representative of composition uncertainty from composition uncertainty module 504. The composition uncertainty module 504 can provide uncertainty data for each of a number of substances (e.g., gasses) including but not limited to carbon dioxide, water, nitrogen, carbon monoxide, oxygen, etc. The composition uncertainty values can be provided by composition sensors. Flare gas uncertainty calculator 502 receives data representative of flow rate uncertainty from flow rate uncertainty module 506. The flow rate uncertainty values can be provided by flow rate sensors, such as ultrasonic flow rate sensors or other meters.

Flare gas uncertainty calculator 502 also receives data representative of wind direction from module 508 and wind speed form module 510. Flare gas uncertainty calculator 502 also receives data representative of added air uncertainty at the site from module 512, added steam uncertainty from module 514, and added fuel uncertainty from module 516. Flare gas uncertainty calculator 502 also receives data representative of combustion efficiency (CE) uncertainty from module 518, and data representative of destruction and removal efficiency (DRE) uncertainty from module 520. The data representative of combustion efficiency uncertainty, and the data destruction and removal efficiency uncertainty can be calculated values using uncertainty parameters associated with the parameters used to calculate combustion efficiency uncertainty and the data destruction and removal in module 404.

Flare gas uncertainty calculator 502 provides flare gas carbon dioxide relative uncertainty data, flare gas carbon dioxide absolute uncertainty data. Flare gas carbon dioxide relative uncertainty data is uncertainty data referenced to the amount of carbon dioxide emissions and can be given as a percentage. Flare gas uncertainty calculator 502 also provides data representative of flare carbon dioxide K, data representative of flare carbon dioxide Sen s, and data representative of composition uncertainty contribution, the flow uncertainty contribution, the wind direction uncertainty contribution, the wind speed uncertainty contribution, the added air uncertainty contribution, the added steam uncertainty contribution, the added fuel uncertainty contribution, the CE uncertainty contribution, and DRE uncertainty contribution. Flare carbon dioxide K is a coverage factor is representative of the number of standard deviations that the uncertainty represents. Flare carbon dioxide Sen s is a table of values that show the sensitivity of the output uncertainties to the input uncertainties. Each material in the composition can have its own uncertainty associated with its measurement.

System 500 can include a single site uncertainty calculator for the data of single site raw emissions cost calculator 414 that accumulates the uncertainty for each output. For example, the uncertainty for each input and its contribution to site carbon dioxide emissions can be calculated to provide an uncertainty value for all sources of carbon dioxide of the site. Similarly, system 500 can include a multi-site uncertainty calculator for the data of multi-site emissions calculator 416 that accumulates the uncertainty for each site. For example, the uncertainty for the carbon dioxide emission at each site can be calculated to provide an uncertainty value for all sites. System 500 can include a carbon dioxide intensity uncertainty calculator for the data of carbon dioxide intensity calculator 418 that uses the uncertainty of the carbon dioxide emissions along with an uncertainty related to the production parameters. System 500 combines uncertainty contributions taking into account their effect on the overall uncertainty for the flare gas uncertainty. For example if wind speed has a high uncertainty, but has far less effect to the flare carbon dioxide emission measurement than flow rate uncertainty, the wind speed uncertainty will not contribute as much to the flare rate uncertainty as the flow rate uncertainty. Coefficients can be used to weight contributive uncertainty values in some embodiments.

In some embodiments, system 500 determines carbon dioxide emission uncertainty by adding the appropriate uncertainty contribution of each source of carbon dioxide. Each uncertainty value can be normalized according to the amount of emission from the source. For example, system 400 can use the following relationship to determine uncertainty for a site: Site carbon dioxide emissions uncertainty=U₁E₁/Eₜₒₜₐₗ+U₂E₂/Eₜₒₜₐₗ+U₃E₃/Eₜₒₜₐₗ+U₄E₄/Eₜₒₜₐₗ+ . . . UₙEₙ/Eₜₒₜₐₗ, where n is any integer, Uₙ is the relative uncertainty value for a source n, Eₙ is the carbon dioxide amount for a source n, and Eₜₒₜₐₗ=E₁+E₂+E₃+E₄ . . . +Eₙ. In some embodiments, U₁ is uncertainty related to field gas carbon dioxide emissions, E₁ is field gas carbon dioxide emissions, U₂ is uncertainty related to flare gas carbon dioxide emissions, E₂ is flare gas carbon dioxide emissions, U₃ is uncertainty related to venting gas carbon dioxide emissions, and E₃ is venting carbon dioxide emissions. For example, system 400 can use the following relationship to determine uncertainty for multiple site: Multisite carbon dioxide emissions uncertainty=US₁ES₁/ESₜₒₜₐₗ+US₂ES₂/ESₜₒₜₐₗ+US₃ES₃/ESₜₒₜₐₗ+US₄ES₄/ESₜₒₜₐₗ+USₙESₙ/ESₜₒₜₐₗ, where n is any integer, USₙ is the relative uncertainty value for a site n, ESₙ is the carbon dioxide amount for the site n, and ESₜₒₜₐₗ=ES₁+ES₂+ES₃+ES₄ . . . +ESₙ. Uncertainty for raw costs can be determined using the uncertainty for an operation, a site or sites and applying the uncertainty associated with the cost aspects.

In some embodiments, uncertainty values are accumulated across a large number of instruments (e.g., meters, sensors, etc.) and bundled for particular measurements. Uncertainty can be related to the time of last calibration, consistency with other instrument readings, consistency of power supply, the length of run time, etc. System 500 can include tables defining uncertainty levels and contributions by equipment under certain criteria. For example, uncertainty levels for equipment may increase or decrease depending on the magnitude of the measurement or environmental conditions.

In some embodiments, system 500 can provide reports for viewing on any of computing devices or systems 26 (FIG. 1). For example, all generated data can be aggregated into a fiscal report which provides combined emission totals and combined uncertainty for those totals for an operation, a site, multiple sites, a venture, a regions, etc. In some embodiments, an emissions intensity report can provide cost per production values with uncertainty (e.g., dollars of emission costs per dollars of product or weight of product produced). Uncertainty values provided in reports or on a live dashboard can assist in avoiding thresholds where costs increase due to exceeding thresholds set forth in tariffs, etc. For example, emissions being close to a threshold with large uncertainty is an indication that future operations may exceed the threshold.

Reporting uncertainty in a live dashboard allows operators adjust operations to reduce uncertainty. For example, a high uncertainty with respect to flow rate may indicate that a flow meter should be recalibrated, replaced, or repaired. In another example, if flow uncertainty is dominant, the operator may reduce flow rate to rates where the uncertainty is decreased or recalibrate, replace, or repair the flow meter. Live uncertainty data for other analyzers or sensors (composition sensors) may also provide information for adjustments with respect to those values and equipment. In some embodiments, if certain added gasses have dominant uncertainty, the amount of those added gasses may be adjusted for the flare operation.

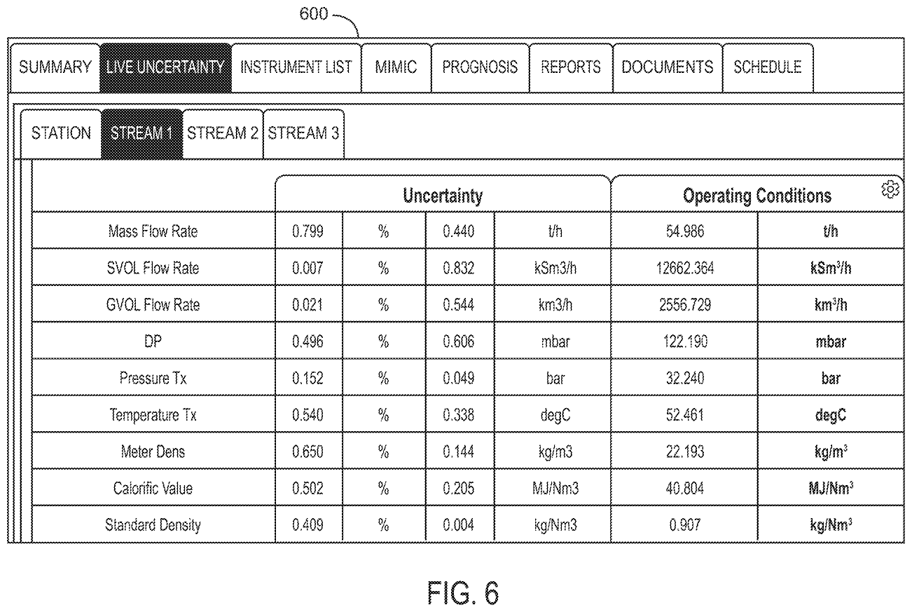

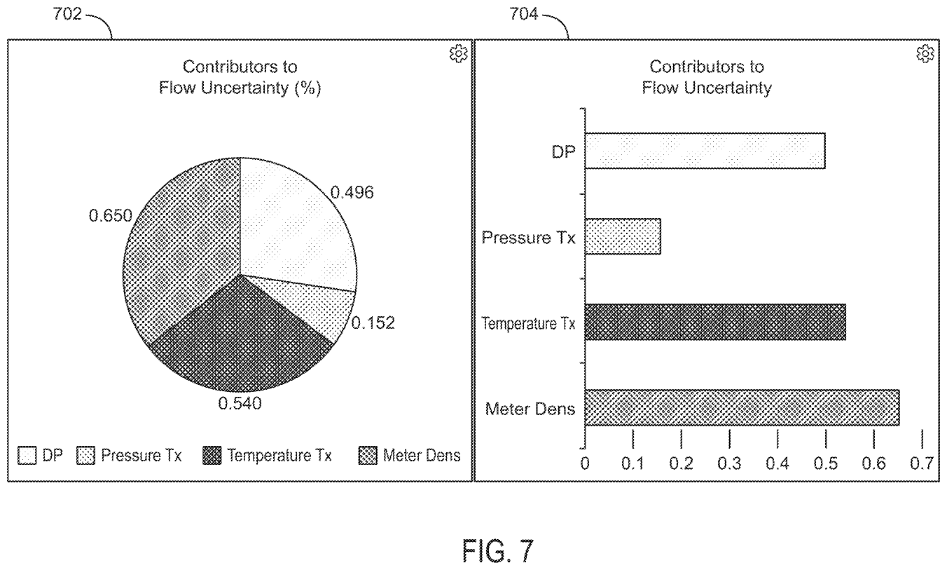

With reference to FIG. 6, a table 600 can be provided by systems 400 and 500. Table 600 reports absolute and relative uncertainty for parameters such as, flow rates, differential pressure, pressure, temperature, meter density, caloric value, and standard density. The uncertainty is reported with the operating condition parameters for each uncertainty value. With reference to FIG. 7, a pie chart 702 can be provided by systems 400 and 500 which shows uncertainty percentages for parameters such as, differential pressure, pressure, temperature, and meter density. A bar graph 704 can be provided by systems 400 and 500 which shows uncertainty percentages for parameters such as, differential pressure, pressure, temperature, and meter density.

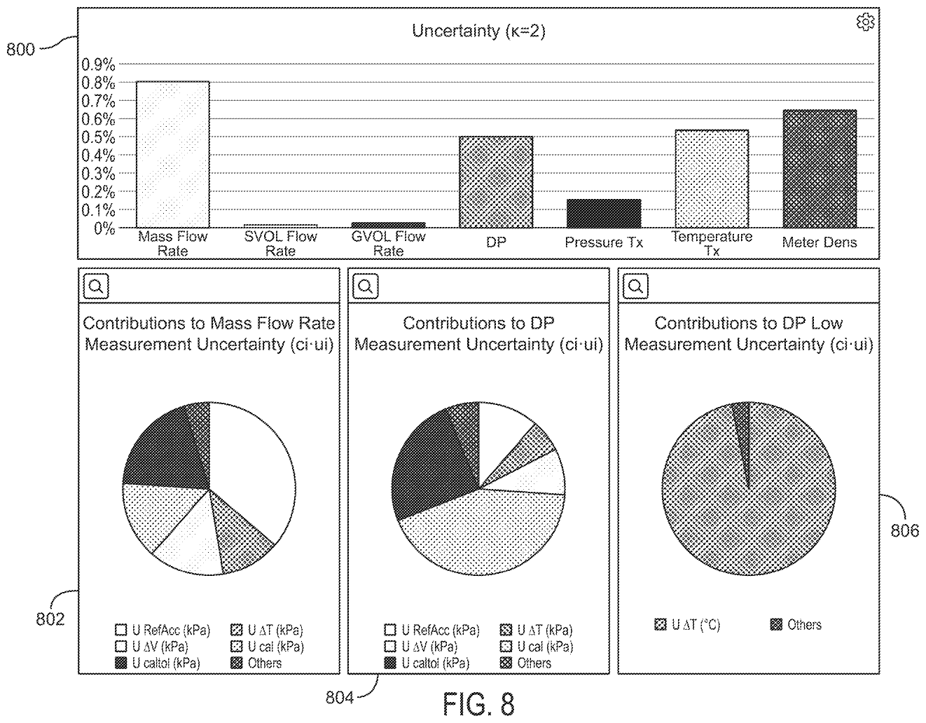

With reference to FIG. 8, a bar graph chart 800 can be provided by systems 400 and 500. Chart 800 reports relative uncertainty for parameters such as, flow rates, differential pressure, pressure, temperature, and meter density. Pie charts 802, 804, and 806 can be provided by systems 400 and 500 which shows contributions to uncertainty. For example, chart 802 shows contributions to mass flow rate measurement uncertainty. Chart 804 shows contributions to differential pressure measurement uncertainty. Chart 806 shows contributions to differential pressure low measurement uncertainty.

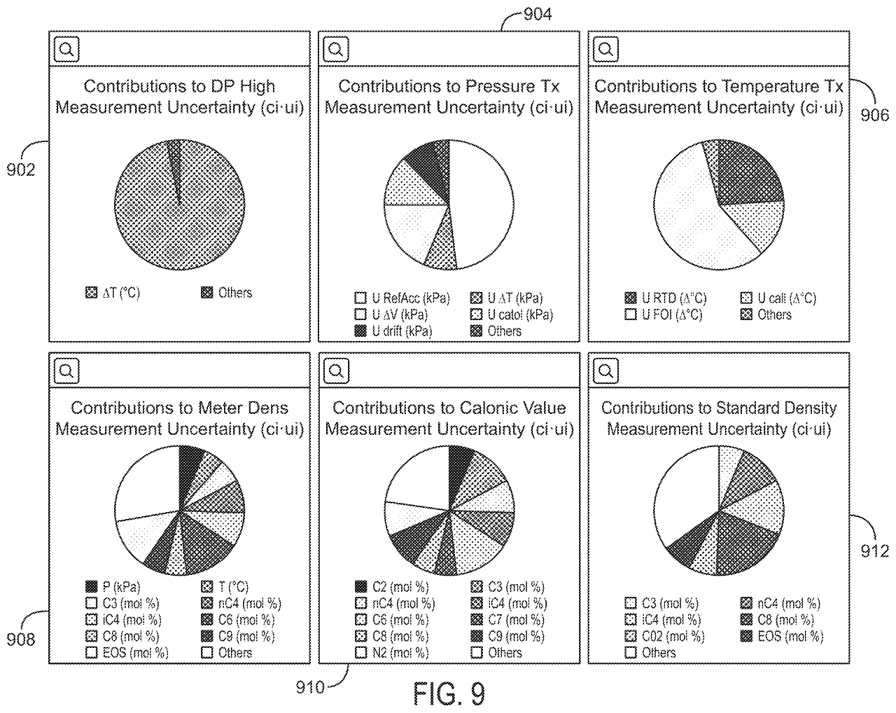

With reference to FIG. 9, a bar graph charts 902, 904, 906, 908, 910, and 912 can be provided by systems 400 and 500. Chart 902 shows contributions to differential pressure low measurement uncertainty. Chart 904 shows contributions to pressure measurement uncertainty. Chart 906 shows contributions to temperature measurement uncertainty. Chart 908 shows contributions to meter density measurement uncertainty. Chart 910 shows contributions to caloric value measurement uncertainty. Chart 912 shows contributions to standard density measurement uncertainty. The information provided in Figured 6-9 can be provided in real time to provide better understanding of uncertainty sources and possible remedial actions in some embodiments.

The modules and calculators described above can include one or processors and/or memory configured by software, the modules may operate on one or more servers and client devices and be coupled with sensors, analyzers, controllers, RTUs, and data bases. The modules and calculators may include general purpose or specific purpose processors (e.g., part of computers, servers, work stations, RTUs, etc.), an application specific integrated circuit (ASICs), one or more field programmable gate arrays (FPGAs), a group of processing components, or other suitable processing components. Modules and calculators are configured to execute computer code or instructions stored in memory or received from other computer readable media (e.g., CDROM, network storage, data bases, flash memory, a remote server, etc.). The modules and calculators described above are performed on one or more computers or servers in some embodiments.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A computing system comprising;
a sensor configured to measure a flow rate; and
a processor configured to:
receive the flow rate and determine an amount of emissions associated with the flow rate and an uncertainty value for the amount of emissions.

2. The method of claim 1, wherein the flow rate is associated with a flare operation, and the processor is configured to receive a composition measurement, an uncertainty parameter associated with the flow rate and an uncertainty parameter associated with the composition measurement, and wherein the amount of emissions is related to the composition measurement and the uncertainty value is determined using the uncertainty parameter associated with the flow rate and the uncertainty parameter associated with the composition measurement.

3. The computing system of claim 1, wherein the flow rate is associated with a flare operation, and the processor is configured to receive a composition measurement, an uncertainty parameter associated with the flow rate, an uncertainty parameter associated with the composition measurement, weather information, and an uncertainty parameter associated with the weather information, and wherein the amount of emissions is related to the composition measurement and the weather information and the uncertainty value is determined using the uncertainty parameter associated with the flow rate, the uncertainty parameter associated with the composition measurement and the uncertainty parameter associated with the weather information.

4. The computing system of claim 1, wherein the flow rate is associated with a flare operation, and the processor is configured to receive a composition measurement, an uncertainty parameter associated with the flow rate, an uncertainty parameter associated with the composition measurement, weather information, an uncertainty parameter associated with the weather information, an added material measurement, and an uncertainty parameter associated with the added material measurement, and wherein the amount of emissions is related to the composition measurement, the added material measurement, and the weather information and the uncertainty value is determined using the uncertainty parameter associated with the flow rate, the uncertainty parameter associated with the composition measurement, the uncertainty parameter associated with the weather information, and the uncertainty parameter associated with the added material measurement.

5. The computing system of claim 4, wherein the added material measurement is for added fuel, added air or added steam.

6. The computing system of claim 4, wherein the weather information is wind speed or wind direction.

7. The computing system of claim 1, wherein the processor is configured to:
determine a combustion efficiency measurement, and a destruction and removal efficiency measurement, an uncertainty parameter for the combustion efficiency measurement, and an uncertainty parameter for the destruction and removal efficiency measurement.

8. The computing system of claim 1, wherein the processor is configured to:
determine a carbon dioxide emission site measurement and uncertainty parameter for the carbon dioxide emission site measurement.

9. The computing system of claim 1, wherein the processor is configured to:
determine a carbon dioxide emission multi-site measurement and uncertainty parameter for the carbon dioxide emission multi-site measurement.

10. The computing system of claim 1, wherein the processor is configured to:
determine an emissions cost estimate measurement and uncertainty parameter for the emissions cost estimate measurement.

11. A computing system to communicatively couple with a remote terminal unit (RTU) configured to monitor and/or control one or more operations of one or more site devices associated with a hydrocarbon site, the computing system comprising;
a processor configured to:
determine an amount of emissions associated with a flare operation at the hydrocarbon site and an uncertainty value for the amount of emissions associated with the flare operation;
determine an amount of emissions associated with fuel used at the hydrocarbon site and an uncertainty value for the amount of emissions associated with the fuels;
determine a total emissions for the hydrocarbon site using the amount of emissions associated with the flare operation and the amount of emissions associated with the fuels; and
determine an uncertainty parameter for the total emissions for the hydrocarbon site using the uncertainty parameter for the amount of emissions associated with the flare operation and the uncertainty parameter for the amount of emissions associated with the fuels.

12. The computing system of claim 11, wherein the amount of emissions associated with the fuel uses a fuel grade measurement, a gauge reading, and an efficiency parameter.

13. The computing system of claim 11, the processor is configured to receive a composition measurement, an uncertainty parameter associated with a flow rate associated with the flare operation, an uncertainty parameter associated with the composition measurement, weather information, and an uncertainty parameter associated with the weather information, and wherein the amount of emissions associated with the flare operation is related to the composition measurement and the weather information and the uncertainty parameter for the amount of emissions associated with the flare operation is determined using the uncertainty parameter associated with the flow rate, the uncertainty parameter associated with the composition measurement and the uncertainty parameter associated with the weather information.

14. The computing system of claim 13, wherein the processor is configured to receive an added material measurement, and an uncertainty parameter associated with the added material measurement, and wherein the amount of emissions associated with the flare operation is related to the added material measurement and the uncertainty parameter for the amount of emissions associated with the flare operation is determined using the uncertainty parameter associated with the added material measurement.

15. The computing system of claim 14, wherein the added material measurement is for added fuel, added air or added steam.

16. The computing system of claim 14, wherein the weather information is wind speed or wind direction.

17. The computing system of claim 14, wherein the processor is configured to:
determine a combustion efficiency measurement for the hydrocarbon site, a destruction and removal efficiency measurement for the hydrocarbon site, an uncertainty parameter for the combustion efficiency measurement, and an uncertainty parameter for the destruction and removal efficiency measurement.

18. The computing system of claim 14, wherein the processor is configured to:
determine a carbon dioxide emission site measurement and uncertainty parameter for a number of hydrocarbon sites.

19. A method comprising:
receiving a flow rate for a flare operation;
receiving an uncertainty parameter for the flow rate;
determining an amount of emissions for the flare operation using the flow rate;
determining an uncertainty value for the amount of emissions using the uncertainty parameter for the flow rate; and
reporting compliance with a flare gas consent using the uncertainty value for the amount of emissions and the amount of emissions for the flare operation.

20. The method of claim 19, further comprising:
receiving a composition measurement, an uncertainty parameter associated with the flow rate and an uncertainty parameter associated with the composition measurement, and wherein the amount of emissions for the flare operation is related to the composition measurement and the uncertainty value for the amount of emissions is determined using the uncertainty parameter associated with the flow rate and the uncertainty parameter associated with the composition measurement.
